(19) United States
(12) Patent Application Publication
(10) Pub. No.: US 2012/0221464 A1
(43) Pub. Date: Aug. 30, 2012

(54) COMMUNICATIONS SYSTEM FOR PERFORMING SECURE TRANSACTIONS BASED UPON MOBILE WIRELESS COMMUNICATIONS DEVICE PROXIMITY AND RELATED METHODS

(75) Inventors: JEROME PASQUERO, Kitchener (CA); David Ryan Walker, Waterloo (CA)

(73) Assignee: Research In Motion Limited, Waterloo (CA)

(21) Appl. No.: 13/036,827

(22) Filed: Feb. 28, 2011

(51) Int. Cl. G06Q 40/00; G06F 21/00; H04W 12/00; H04B 5/00; H04W 4/02

(52) U.S. Cl. 705/39; 455/41.1; 455/41.2; 455/39; 455/414.1; 726/26

(57) ABSTRACT

A communications system may include a plurality of mobile wireless communications devices configured to determine proximity between one another. At least one of the mobile wireless communications devices may also be configured to generate a secure transaction request based upon the determined proximity. The system may further include a transaction terminal configured to receive the secure transaction request and perform a secure transaction based thereon.

### TECHNICAL FIELD

This application relates to the field of communications, and more particularly, to wireless communications devices and related methods.

### BACKGROUND

Mobile communication systems continue to grow in popularity and have become an integral part of both personal and business communications. Various mobile devices now incorporate Personal Digital Assistant (PDA) features such as calendars, address books, task lists, calculators, memo and writing programs, media players, games, etc. These multi-function devices usually allow electronic mail (email) messages to be sent and received wirelessly, as well as access the Internet via a cellular network and/or a wireless local area network (WLAN), for example.

Some mobile devices incorporate contactless card technology and/or near-field communication (NFC) chips. NFC technology is used for contactless short-range communications based on radio frequency identification (RFID) standards, using magnetic field induction to enable communication between electronic devices, including mobile wireless communications devices. This short-range high frequency wireless communications technology exchanges data between devices over a short distance, such as only a few centimeters.

### BRIEF DESCRIPTION OF THE DRAWINGS

FIG. 1 is a schematic block diagram of an example communications system for performing secure transactions based mobile wireless communications device proximity.

FIG. 2 is a schematic block diagram of an alternative example embodiment of the communications system of FIG. 1.

FIG. 3 is a schematic block diagram of an example mobile wireless communications device for use with the communications system of FIG. 2.

FIGS. 4-6 are flow diagrams illustrating example method aspects associated with the communications systems of FIGS. 1 and 2.

FIG. 7 is a schematic block diagram illustrating example components which may be used in the mobile wireless communications devices of FIGS. 1 through 3.

### DETAILED DESCRIPTION

The present description is made with reference to the accompanying drawings, in which example embodiments are shown. However, many different embodiments may be used, and thus the claims should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

Generally speaking, a communications system is provided herein which may include a plurality of mobile wireless communications devices configured to determine proximity between one another. At least one of the mobile wireless communications devices may also be configured to generate a secure transaction request based upon the determined proximity. The system may further include a transaction terminal configured to receive the secure transaction request and perform a secure transaction based thereon. Accordingly, the communications system may advantageously provide a relatively quick and convenient approach for third party authorization of secure transactions based upon proximity.

By way of example, the plurality of mobile wireless communications devices may be configured to be wirelessly paired together via near-field communication (NFC) when in proximity to one another. In accordance with another example, the plurality of mobile wireless communications devices may be configured to be wirelessly paired together via Bluetooth communication when in proximity to one another. Also by way of example, the secure transaction may comprise a secure financial transaction, a secure physical access operation, etc. Furthermore, the at least one mobile wireless communications device may send the secure transaction request via NFC, Bluetooth, etc., for example. Additionally, the plurality of mobile wireless communications devices may comprise cellular transceivers and may be configured to determine proximity to one another based upon communications with a cellular network.

A similar communications system may include a plurality of mobile wireless communications devices, where at least one of the mobile wireless communications devices may be configured to generate a secure transaction request. The system may also include a transaction terminal configured to receive the secure transaction request, determine whether the plurality of mobile wireless communications devices are in proximity to one another, and perform a secure transaction based upon the received secure transaction request and the plurality of mobile wireless communications devices being in proximity to one another.

A related transaction terminal may include a wireless receiver and a controller coupled therewith and configured to receive a secure transaction request from at least one of a plurality of mobile wireless communications devices, and determine whether the plurality of mobile wireless communications devices are in proximity to one another. The controller may be further configured to perform a secure transaction based upon the received secure transaction request and the plurality of mobile wireless communications devices being in proximity to one another.

A related communications method may include determining proximity between a plurality of mobile wireless communications devices, and generating a secure transaction request from at least one of the mobile wireless communications devices based upon the determined proximity. The method may further include receiving the secure transaction request at a transaction terminal and performing a secure transaction with the transaction terminal based thereon.

Another related communications method may include generating a secure transaction request from at least one of a plurality of mobile wireless communications devices, receiving the secure transaction request at a transaction terminal, and determining, with the transaction terminal, whether the plurality of mobile wireless communications devices are in proximity to one another. The method may further include performing a secure transaction with the transaction terminal based upon the received secure transaction request and the plurality of mobile wireless communications devices being in proximity to one another.

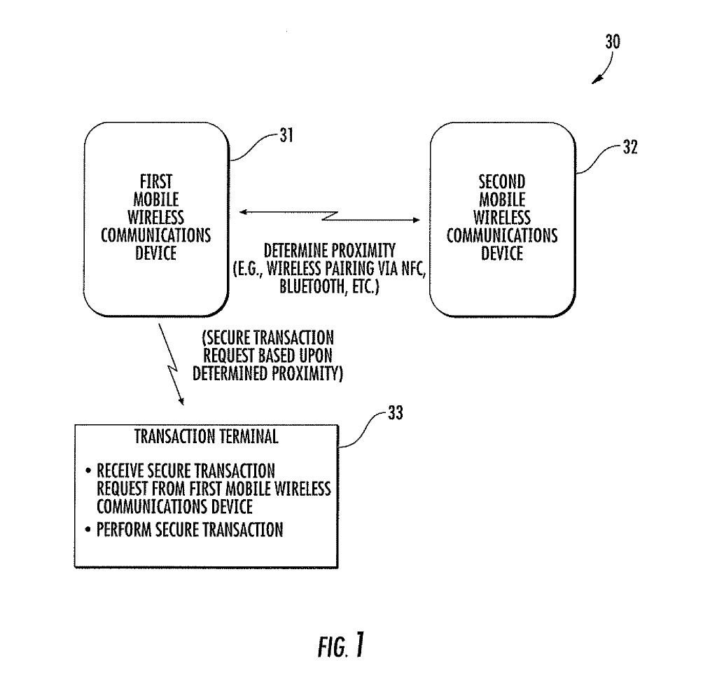

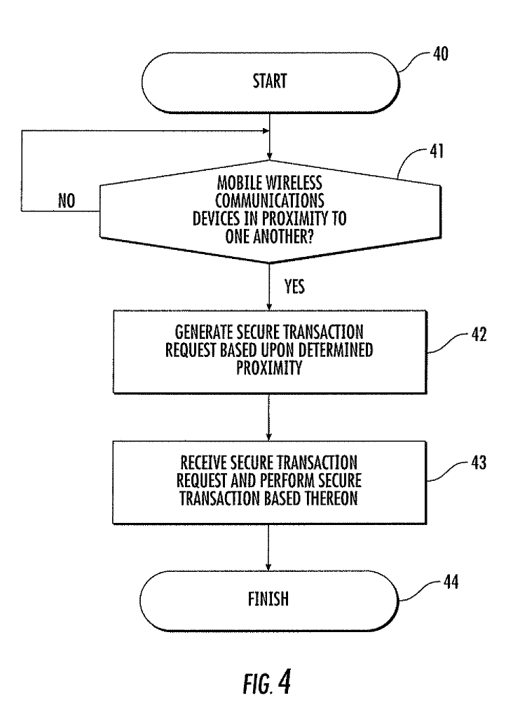

Referring initially to FIGS. 1-6, a communications system 30 and related method aspects are first described. Generally speaking, the communications system 30 may advantageously provide for enhanced speed, security, and customization of mobile transactions. More particularly, the system 30 illustratively includes first and second mobile wireless communications devices 31, 32 (also referred to as “mobile devices” herein), and a transaction terminal 33. Beginning at Block 40 (see FIG. 4), one or more of the mobile devices 31, 32 is configured to generate a secure transaction request based upon a determination that the mobile devices are in proximity to one another, at Blocks 41-42. The secure transaction request is communicated or sent to a transaction terminal 33, which is configured to receive the secure transaction request and perform a secure transaction based thereon, at Block 43, which concludes the method illustrated in FIG. 4 (Block 44). Example mobile devices 31, 32 may include portable or personal media players (e.g., MP3 players, video players, etc.), remote controls (e.g., television or stereo remotes, etc.), portable gaming devices, portable or mobile telephones, smartphones, etc.

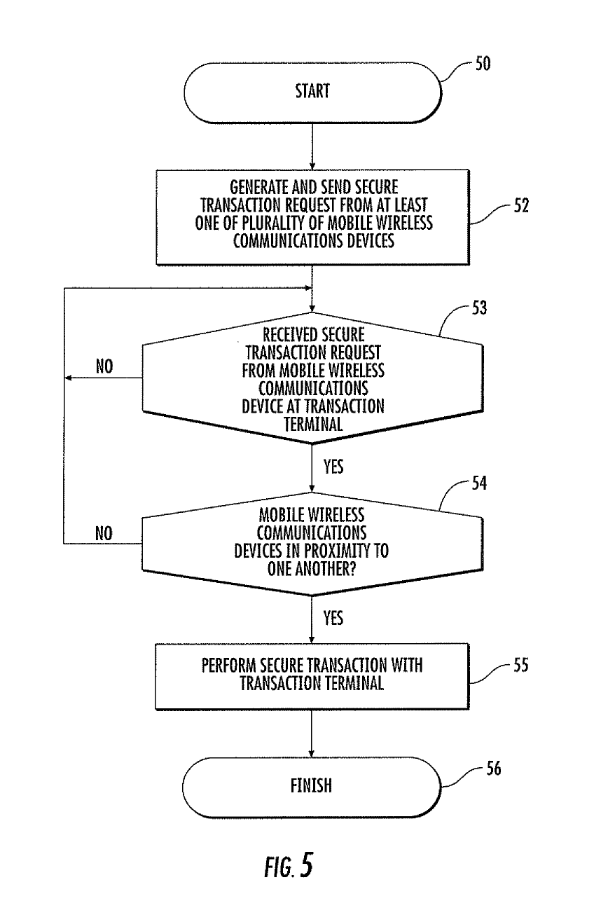

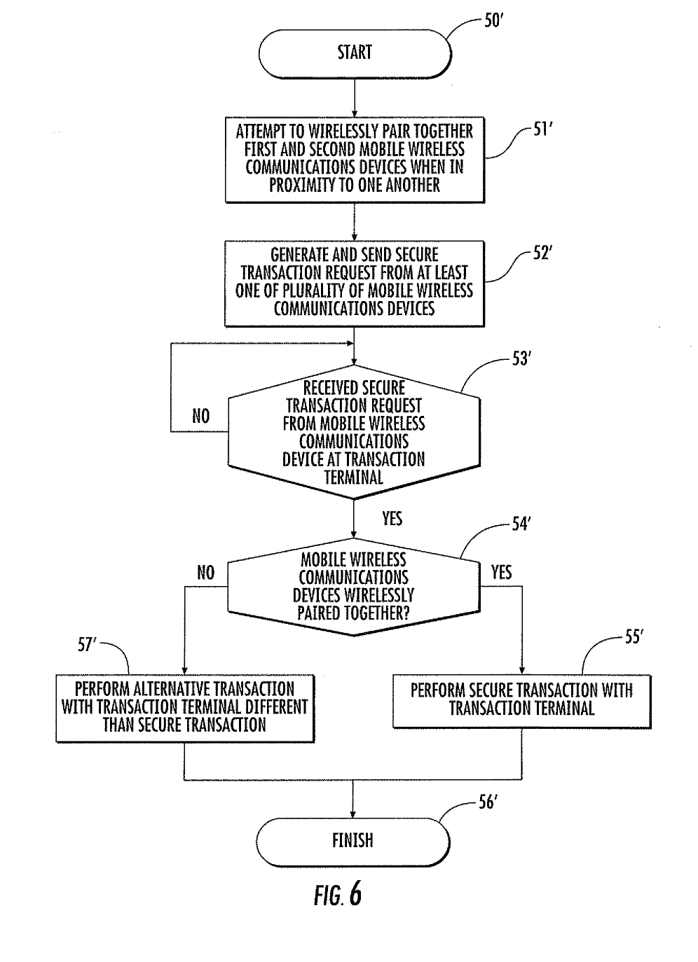

Beginning at Blocks 50, 50′ (see FIGS. 5-6), the first and second mobile devices 31, 32, when in proximity to one another, may be configured to wirelessly pair together with one another, at Block 51′. That is, proximity between the first and second mobile devices 31, 32 may be determined based upon the mobile devices coming within wireless communications range of one another. For example, the first and second mobile devices 31, 32 may be configured to communicate via near-field communication (NFC), and therefore use NFC for wireless pairing therebetween.

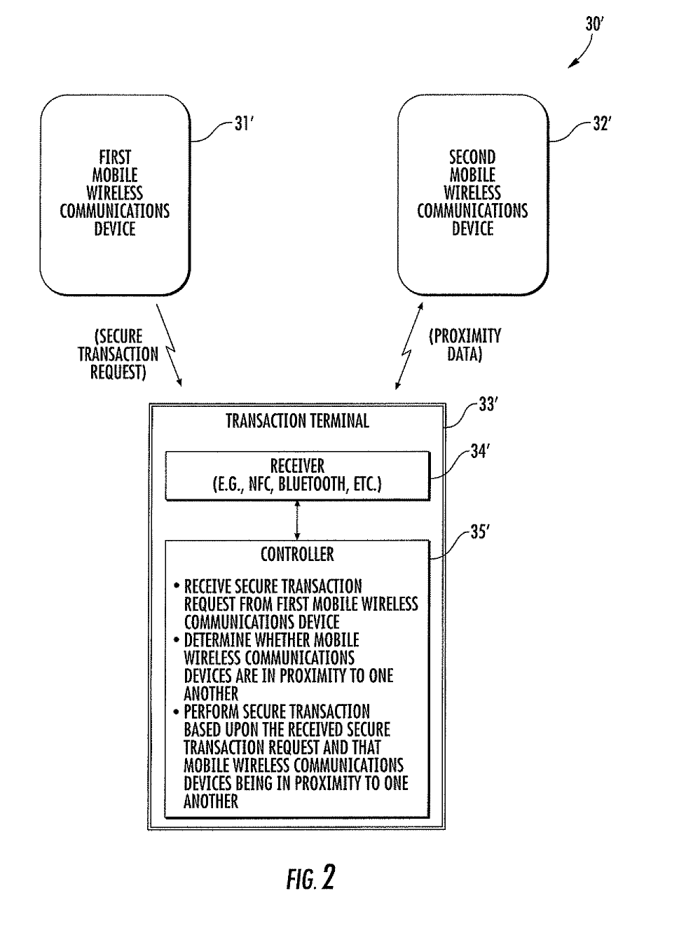

By way of background, NFC is a short-range wireless communications technology in which NFC-enabled devices are “swiped,” “bumped” or otherwise moved in close proximity to communicate. In one non-limiting example implementation, NFC may operate at 13.56 MHz and with an effective range of about 10 cm, but other suitable versions of near-field communication which may have different operating frequencies, effective ranges, etc., for example, may also be used. Another example wireless communications format that may be used for pairing of the first and second mobile devices 31, 32 is Bluetooth. As shown in FIG. 2, the transaction terminal 33′ may similarly include a receiver 34′ (or transceiver) configured to communicate via NFC, Bluetooth, etc.

However, it should be noted that other approaches besides wireless pairing for determining proximity between the first and second mobile devices 31, 32 may also be used in some embodiments. For example, Internet-based services such as Google Latitude allow mobile device users to track the whereabouts of one another based upon global positioning system (GPS) measurements, cell tower triangulation, etc. This is one example approach by which the first mobile device 31 may determine that the second mobile device 32 is in proximity thereto, or vice-versa. Other similar location or tracking services or systems may also be used.

By way of example, the secure transaction request may be for a secure financial transaction, such as a purchase transaction if the transaction terminal 33 is a point-of-sale (POS) terminal. Other types of financial transactions may include monetary withdrawals where the transaction terminal 33 is an Automated Teller Machine (ATM) or similar monetary dispensing device, adding funds to a payment card (e.g., gift card, etc.), electronic fund transfers between different accounts, etc.

Still other examples of secure transactions which may be requested by the first mobile device 31 may include secure physical access operations. For example, the first mobile device 31 may generate or initiate a request to access a secure area, such as a safe or safe deposit box, or even a larger area such as a locked room or building, which is opened by the transaction terminal 33. it should be noted that in some embodiments the transaction terminal 33 may be remotely located from the first mobile device 31, such as where the transaction terminal comprises an Internet server that the first mobile devices accesses through a mobile browser or other mobile applications, for example.

Accordingly, the first mobile device 31 is permitted to generate and send the secure transaction request based upon the second mobile device 32 being in proximity thereto. Stated alternatively, the second mobile device 32 advantageously authorizes the first mobile device 31 to perform the desired security transaction and send the secure transaction request to the transaction terminal 33 based upon being in proximity thereto. In some embodiments, the first mobile device may be configured to send a secure transaction request for a different secure operation (e.g., a purchase not exceeding a threshold amount, etc.) if the second mobile device 32 is not in proximity to the first mobile device 31 to thereby authorize the transaction. Also, in some embodiments the second mobile device 32 may also be required to provide or grant permission for the secure transaction request, such as through a user interface which prompts a user of the second device to acknowledge that the requested secure transaction is permissible for the first mobile device 31.

It should be noted, however, that in some embodiments the second mobile device 32 may communicate the secure transaction request to the transaction terminal 33. For example, when in proximity to the second mobile device 32, the first mobile device 31 may request that the second mobile device authorize the desired secure transaction, and the second mobile device communicates the authorized secure transaction request to the transaction terminal 33.

In certain embodiments, such as the example embodiment shown in FIG. 2, the transaction terminal 33′ may make the determination as to whether the first and second mobile devices 31′, 32′ are in proximity and, therefore, whether the requested secure transaction is authorized. That is, in the above-described example configuration illustrated in FIG. 1, the transaction terminal 33 is not required to make determinations or decisions as to whether the first and second mobile devices 31, 32 are in proximity to one another (although it may do so in some embodiments), but instead performs the requested transaction upon receiving a valid secure transaction request.

Here again, the first mobile device 31′ is configured to generate and send a secure transaction request, at Blocks 52, 52′. The transaction terminal 33′ further illustratively includes a controller 35′ coupled with the receiver 34′. The controller 35′ is configured to receive the secure transaction request via the receiver 34′ from the first mobile device 31′, at Blocks 53, 53′, and to determine that the first and second mobile devices 31, 32 are in close proximity, such as by being wirelessly paired together, at Blocks 54, 54′. Upon the occurrence of these conditions, the requested secure transaction is performed, at Blocks 55, 55′, which concludes the illustrated methods (Blocks 56, 56′). If all of the conditions do not occur or are not met, then the transaction may fail, timeout, or be cancelled in some example embodiments. The controller 35′ may be implemented using a combination of hardware (e.g., microprocessor, memory, etc.) and software components, such as a computer-readable medium having computer-executable instructions for performing the operations described herein.

In this way, the transaction terminal 33 may advantageously use information about trusted family members, friends, etc., that are physically present or in proximity to the first mobile device 31′ (and, therefore, the user requesting the secure transaction) to authorize or otherwise validate the secure transaction, whereas the given transaction would not otherwise occur or be permitted without such authorization or validation. That is, the first mobile device 31′ would not otherwise be authorized for, or have access to, the given secure transaction by itself or without separate identification. However, when in proximity or wirelessly paired with the second mobile device 32′, the first mobile device 31′ is authorized or otherwise validated for the secure transaction because of the proximity of the particular user known to be assigned to or associated with the second mobile device.

Data indicating that the second mobile device 32′ is permitted to authorize a secure transaction for the first mobile device 31′ may be stored by the controller 35′ (e.g., in a database or memory) in some example embodiments. Thus, once the controller 35′ determines the second mobile device 32′ is paired with the first mobile device 31′ (which it may do through communication with the first mobile device, or through separate communication directly with the second mobile device in some embodiments), it may compare an identification number (e.g., PIN, IMEI, etc.) associated with the second mobile device to its database to see if the second mobile device is a designated or authorization device for the first mobile device. In other example embodiments, the first mobile device 31′ may pass along valid financial or access data (e.g., credit or debit card number, account number, password, etc.) from the second mobile device 32′ in an encrypted form that authorizes the secure transaction.

In the context of a secure financial transaction example, the first mobile device 31, 31′ may be assigned to or associated with a child who is attempting to purchase an item at the transaction terminal 33, 33′ (e.g., a POS terminal). The second mobile device 32, 32′ may be assigned to or associated with a parent or guardian of the child. Because the first and second mobile devices 31, 31′ and 32, 32′ are in proximity to one another or wirelessly paired, the transaction terminal 33, 33′ is configured to accept this as an authorization from the second mobile device (and, thus, the parent) for the child (i.e., the first mobile device) to complete the purchase because of the proximity of the second mobile device to the first mobile device. It should be noted that the first and second mobile devices 31, 31′ and 32, 32′ may be wirelessly paired before or after the first mobile device wirelessly sends the secure transaction request depending on the given implementation.

In accordance with another example, if the first and second mobile devices 31, 31′ and 32, 32′ are in proximity or paired together, the user of the first mobile device 31, 31′ may not be prompted to provide a password or other identifier, whereas if the two devices were not in proximity or paired then the user of the first mobile device 31, 31′ may have to provide the password to authorize the transaction. In the case of secure physical access, wireless paring between the first and second devices 31, 31′ and 32, 32′, which may respectively be assigned to or associated with a husband and wife, may be required to access a joint safe deposit box of the husband and wife. In such case, either of the mobile devices 31, 31′ and 32, 32′ may be used to send the access request, and the other mobile device then serves as the second authorizing mobile device. In an example of an individual safe deposit box, the first mobile device 31 may be associated with a user or customer, while the second mobile device 32 may be associated with an authorized bank employee, for example.

It should be noted that the controller 35′ may be configured to perform an alternative transaction different than the secure transaction based upon receiving the secure transaction request and determining that the first and second mobile wireless communications devices are not wirelessly paired together, at Block 57′. That is, the transaction terminal 33′ may allow a first transaction if the second mobile device 32′ is in proximity or paired with the first mobile device, and allow a second transaction if not. For example, in the case where the first mobile device 31′ is associated with a child and the second mobile device 32′ is associated with a parent, when the second mobile device is in proximity or paired with the first mobile device, the first mobile device may be permitted to spend a larger amount (e.g., $100), but a lesser amount when they are not in proximity or paired (e.g., $15).

In an example where the first mobile device 31, 31′ is assigned to a wife and the second mobile device 32, 32′ is assigned to her husband, when the two devices are in proximity or wirelessly paired then the transaction terminal may debit a joint bank account belonging to the husband and wife, but debit an individual account belonging solely to the wife if she is shopping alone. Such preferences on which account, etc., to use may be configured on the mobile devices 31, 31′ or 32, 32′ via a graphical user interface, or stored by the controller 35′, for example.

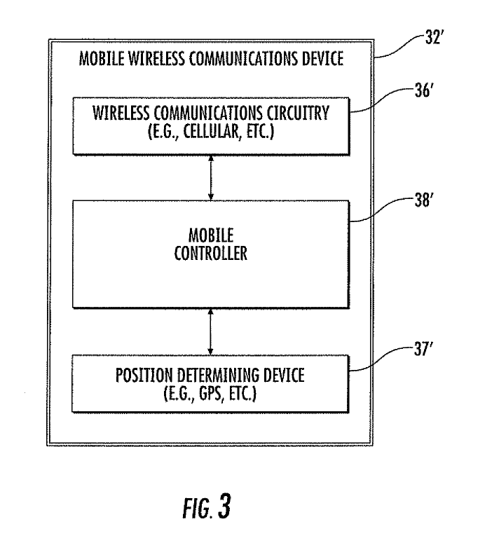

Referring additionally to FIG. 3, in some example embodiments the second mobile device 32, 32′ (or the first mobile device 31, 31′) may further include wireless communications circuitry 36′, such as cellular communications circuitry, a position determining device 37′ (e.g., GPS, Galileo, GLONASS, etc.), and a mobile controller 38′ coupled with the wireless communications circuit and the position determining device. As noted above, the transaction terminal 33′ may communicate directly with the second mobile device 32′ via the wireless (e.g., cellular) communications circuitry 36′ to obtain position information or coordinates by which the controller 35′ may determine whether or not the first and second mobile devices 31′, 32′ are in proximity. In other example embodiments, the transaction terminal 33′ and second mobile device 32′ may communicate directly via NFC, Bluetooth, wireless local area network (WLAN), etc., as well. Another approach which may be used by the transaction terminal 33′ to determine whether the first and second devices 31′, 32′ are in proximity is through a location or tracking service such as the above-noted Google Latitude system, for example.

Various other example embodiments are also possible. Referring again to FIG. 2, the first mobile device 31′ may send a secure transaction request to the transaction terminal 33′, and also send a validation request to the second mobile device 32′ when in proximity thereto. The second mobile device 32′ may then send a copy of the transaction request (or other suitable identifier of the request) to the transaction terminal 33′ along with a confirmation. The controller 35′ will perform the requested security transaction if it has received both the transaction request from the first mobile device 31′ and the confirmation from the second mobile device 32′.

Moreover, various combinations of the above-described example embodiments may also be used, such as to add redundancy to the system 30, 30′ to increase reliability and security. For example, the first mobile device 31, 31′ device may send a transaction validation request to the second mobile device 32, 32′. The second mobile device 32, 32′ validates the secure transaction (through proximity, permission, or both) and sends a transaction request to the transaction terminal 33, 33′. The transaction terminal 33, 33′ determines whether the first and second mobile devices 31, 31′ and 32, 32′ are still within proximity to one another, and processes the secure transaction (or not) accordingly.

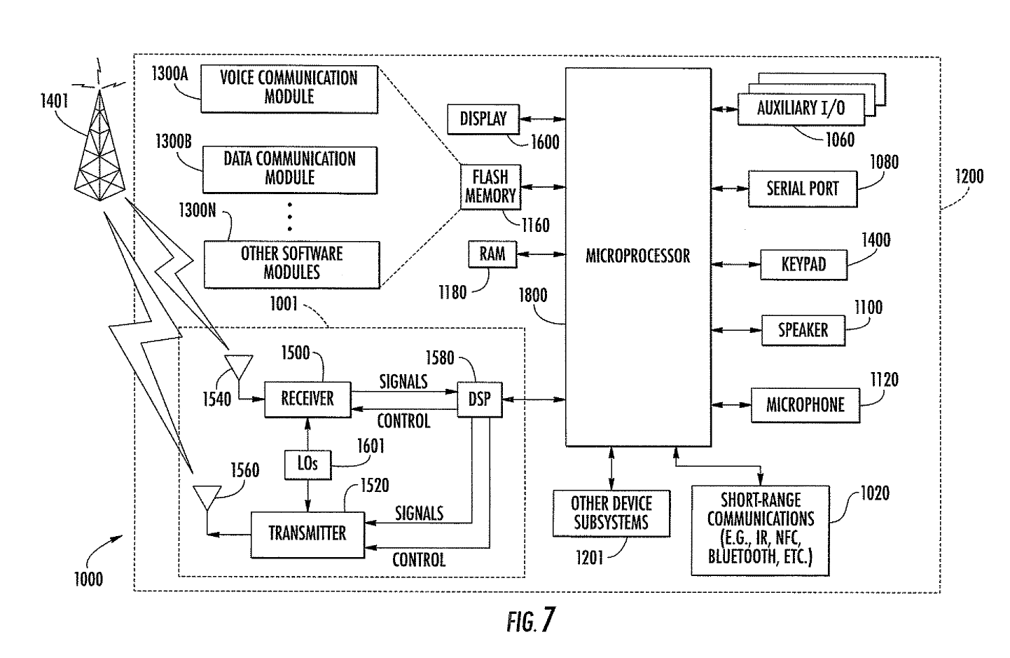

Example components of a mobile device 1000 that may further be used in accordance with the above-described embodiments are now described with reference to FIG. 7. The device 1000 illustratively includes a housing 1200, a keypad or keyboard 1400 and an output device 1600. The output device shown is a display 1600, which may comprise a full graphic LCD. Other types of output devices may alternatively be utilized. A processing device 1800 is contained within the housing 1200 and is coupled between the keyboard 1400 and the display 1600. The processing device 1800 controls the operation of the display 1600, as well as the overall operation of the mobile device 1000, in response to actuation of keys on the keyboard 1400.

The housing 1200 may be elongated vertically, or may take on other sizes and shapes (including clamshell housing structures). The keyboard may include a mode selection key, or other hardware or software for switching between text entry and telephony entry.

In addition to the processing device 1800, other parts of the mobile device 1000 are shown schematically in FIG. 7. These include a communications subsystem 1001; a short-range communications subsystem 1020; the keyboard 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOS) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keyboard 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem 1020 may include an infrared device and associated circuits and components, NFC or a Bluetooth™ communications module to provide for communication with similarly-enabled systems and devices.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A communications system comprising:
a plurality of mobile wireless communications devices configured to determine proximity to one another;
at least one of said mobile wireless communications devices being configured to generate a secure transaction request based upon the determined proximity; and
a transaction terminal configured to receive the secure transaction request and perform a secure transaction based thereon.

2. The communications system of claim 1 wherein said plurality of mobile wireless communications devices are configured to be wirelessly paired together via near-field communication (NFC) when in proximity to one another.

3. The communications system of claim 1 wherein said plurality of mobile wireless communications devices are configured to be wirelessly paired together via Bluetooth communication when in proximity to one another.

4. The communications system of claim 1 wherein the secure transaction comprises a secure financial transaction.

5. The communications system of claim 1 wherein the secure transaction comprises a secure physical access operation.

6. The communications system of claim 1 wherein said at least one mobile wireless communications device sends the secure transaction request via near-field communication (NFC).

7. The communications system of claim 1 wherein said at least one mobile wireless communications device sends the secure transaction request via Bluetooth communication.

8. The communications system of claim 1 wherein said plurality of mobile wireless communications devices comprise cellular transceivers; and wherein said plurality of mobile wireless communications devices are configured to determine proximity to one another based upon communications with a cellular network.

9. The communications system of claim 1 wherein said transaction terminal is further configured to cancel the secure transaction based upon the plurality of mobile wireless communications devices not determining proximity to one another.

10. A communications system comprising:
a plurality of mobile wireless communications devices, at least one of said mobile wireless communications devices being configured to generate a secure transaction request; and
a transaction terminal configured to
receive the secure transaction request,
determine whether said plurality of mobile wireless communications devices are in proximity to one another, and
perform a secure transaction based upon the received secure transaction request and the plurality of mobile wireless communications devices being in proximity to one another.

11. The communications system of claim 10 wherein said plurality of mobile wireless communications devices are configured to be wirelessly paired together via near-field communication (NFC) when in proximity to one another; and wherein said transaction terminal is configured to perform the secure transaction based upon the received secure transaction request and the plurality of mobile wireless communications devices being wirelessly paired together.

12. The communications system of claim 10 wherein said plurality of mobile wireless communications devices are configured to be wirelessly paired together via Bluetooth communication when in proximity to one another; and wherein said transaction terminal is configured to perform the secure transaction based upon the received secure transaction request and the plurality of mobile wireless communications devices being wirelessly paired together.

13. The communications system of claim 10 wherein the secure transaction comprises a secure financial transaction.

14. The communications system of claim 10 wherein the secure transaction comprises a secure physical access operation.

15. The communications system of claim 10 wherein said at least one mobile wireless communications device is configured to send the secure transaction request via near-field communication (NFC).

16. The communications system of claim 10 wherein said at least one mobile wireless communications device is configured to send the secure transaction request via Bluetooth communication.

17. The communications system of claim 10 wherein said transaction terminal is configured to perform an alternative transaction different than the secure transaction based upon receiving the secure transaction request and determining that said first and second mobile wireless communications devices are not in proximity to one another.

18. A transaction terminal comprising:
a wireless receiver; and
a controller coupled with the wireless receiver, the controller being configured to
receive a secure transaction request from at least one of a plurality of mobile wireless communications devices,
determine whether the plurality of mobile wireless communications devices are in proximity to one another, and
perform a secure transaction based upon the received secure transaction request and the plurality of mobile wireless communications devices being in proximity to one another.

19. The transaction terminal of claim 18 wherein the plurality of mobile wireless communications devices are configured to be wirelessly paired together via near-field communication (NFC) when in proximity to one another; and wherein said controller is configured to perform the secure transaction based upon the received secure transaction request and the plurality of mobile wireless communications devices being wirelessly paired together.

20. The transaction terminal of claim 18 wherein the plurality of mobile wireless communications devices are configured to be wirelessly paired together via Bluetooth communication when in proximity to one another; and wherein said controller is configured to perform the secure transaction based upon the received secure transaction request and the plurality of mobile wireless communications devices being wirelessly paired together.

21. The transaction terminal of claim 18 wherein the secure transaction comprises at least one of a secure financial transaction or a secure physical access operation.

22. A communications method comprising:
determining proximity between a plurality of mobile wireless communications devices;
generating a secure transaction request from at least one of the mobile wireless communications devices based upon the determined proximity; and
receiving the secure transaction request at a transaction terminal and performing a secure transaction with the transaction terminal based thereon.

23. The method of claim 22 further comprising wirelessly pairing the plurality of mobile wireless communications devices together via near-field communication (NFC).

24. The method of claim 22 further comprising wirelessly pairing the plurality of mobile wireless communications devices together via Bluetooth communication.

25. The method of claim 22 wherein the secure transaction comprises at least one of a secure financial transaction or a secure physical access operation.

26. A communications method comprising:
generating a secure transaction request from at least one of a plurality of mobile wireless communications devices;
receiving the secure transaction request at a transaction terminal;
determining, with the transaction terminal, whether the plurality of mobile wireless communications devices are in proximity to one another; and
performing a secure transaction with the transaction terminal based upon the received secure transaction request and the plurality of mobile wireless communications devices being in proximity to one another.

27. The method of claim 26 further comprising wirelessly pairing the plurality of mobile wireless communications devices together via near-field communication (NFC) when in proximity to one another; and wherein determining comprises determining whether the plurality of mobile wireless communications are in proximity to one another based upon wireless pairing therebetween.

28. The method of claim 26 further comprising wirelessly pairing the plurality of mobile wireless communications devices together via Bluetooth communication when in proximity to one another; and wherein determining comprises determining whether the plurality of mobile wireless communications are in proximity to one another based upon wireless pairing therebetween.

29. The method of claim 26 wherein the secure transaction comprises at least one of a secure financial transaction or a secure physical access operation.

30. The method of claim 26 further comprising performing an alternative transaction with the transaction terminal different than the secure transaction based upon receiving the secure transaction request and determining that the first and second mobile wireless communications devices are not in proximity to one another.
